(19) United States
(12) Patent Application Publication
(10) Pub. No.: US 2006/0187375 A1
(43) Pub. Date: Aug. 24, 2006

(54) Liquid crystal display apparatus

(75) Inventor: SungKi Kim, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ldt.

(21) Appl. No.: 11/245,093

(22) Filed: Oct. 7, 2005

(30) Foreign Application Priority Data
Feb. 18, 2005 (KR) 2005-0013488
Mar. 2, 2005 (KR) 2005-0017229

(51) Int. Cl. G02F 1/1333

(52) U.S. Cl. 349/60

(57) ABSTRACT

The present invention relates to a liquid crystal display (LCD) apparatus, comprising a liquid crystal panel; a direct type back light unit provided behind the liquid crystal panel which has plurality of lamps; a reflection sheet provided behind the direct type back light unit; a bottom chassis in the rear of the reflection sheet; and a thermal conduction part connected to the bottom chassis and the plural lamps, which conducts heat from the plurality of lamps to the bottom chassis. Thus, the present invention improves the heat radiation system of a direct type back light unit.

### CROSS-REFERENCE TO RELATED APPLICATIONS

This application claims the benefit under 35 U.S.C. §119(a) of Korean Patent Application No. 2005-0013488, filed on Feb. 18, 2005, and Korean Patent Application No. 2005-0017229, filed on Mar. 2, 2005, in the Korean Intellectual Property Office, the entire disclosures of both of which are hereby incorporated by reference.

### BACKGROUND OF INVENTION

1. Field of Invention

The present invention relates to a liquid crystal display (LCD) apparatus. More particularly, the present invention relates to a liquid crystal display apparatus with an improved heat radiation system of a direct type back light unit.

2. Description of the Related Art

Generally, a liquid crystal display comprises a display element, which changes electrical signal information into visual information using the transmittance variation of liquid crystal molecules according to an applied voltage. Such a liquid crystal display apparatus has been applied to monitors, TV sets, and so on.

A back light unit of the liquid crystal display apparatus is classified into two types, a direct type and an edge type, according to the lamp disposition structure. In particular, the direct type back light unit typically maintains a higher brightness, compared with the edge type.

A conventional liquid crystal display apparatus comprises a top chassis, a liquid crystal panel provided behind the top chassis, a direct back light unit provided behind the liquid crystal panel, a reflection sheet provided behind the direct back light unit and a bottom chassis provided behind the reflection sheet.

The direct type back light unit has a plurality of lamps provided behind the liquid crystal panel, which generate more heat than an edge type back light unit. In particular, the inside of the liquid crystal display apparatus has a closed structure, so that the inner temperature may rise higher than a predetermined temperature due to the heat from the plurality of lamps. A rise of the inner temperature may deteriorate lamp life and lamp operation efficiency, and also cause the degradation of the liquid crystal panel.

Accordingly, a heat radiation structure is needed in order to prevent the inner temperature of the back light unit from rising above a predetermined temperature, and to improve the assembly efficiency and the economical efficiency of the heat radiation structure.

### SUMMARY OF THE INVENTION

Accordingly, it is an aspect of the present invention to provide a liquid crystal display apparatus capable of radiating heat generated from a direct type back light unit.

Additional aspects and/or advantages of the invention will be set forth in part in the description which follows and, in part, will be obvious from the description, or may be learned by practice of the invention.

The foregoing and/or other aspects of the present invention are achieved by providing a liquid crystal display apparatus, comprising a liquid crystal panel; a direct type back light unit provided behind the liquid crystal panel, which has a plurality of lamps; a reflection sheet provided behind the direct type back light unit; a bottom chassis provided behind the reflection sheet; and a thermal conduction part connected with the bottom chassis and the plurality of lamps for conducting heat from the plurality of lamps to the bottom chassis.

According to an aspect of the present invention, the thermal conduction part comprises a first side supported by the bottom chassis; and a second side passing through the reflection sheet, and contacting and supporting the external surface of the plurality of lamps. Preferably, the thermal conduction part contacts and supports various portions of the external surface of the plurality of lamps. Preferably, the thermal conduction part is made of a material having high thermal conduction and electrical insulation. Preferably, the thermal conduction part is a synthetic resin with high thermal conductivity. Preferably, the LCD apparatus further comprises an air fluidity generation unit in order to force circulation of the inner air stratified by the heat generated from the plurality of lamps. Preferably, the air fluidity generation unit is installed in order that the unit is not interfered with by the reflection sheet. Preferably, the air fluidity generation unit is located in either an upper part or a lower part of the bottom chassis. Preferably, the air fluidity generation unit comprises a blower using a piezo-electric element.

### BRIEF DESCRIPTION OF THE DRAWINGS

These and other aspects and advantages of the present invention will become apparent and more readily appreciated from the following description of exemplary embodiments, taken in conjunction with the accompany drawings of which:

FIG. 1 is a perspective view of a liquid crystal display apparatus according to an embodiment of the present invention;

FIG. 2 is an exploded perspective view schematically illustrating a configuration of a liquid crystal display apparatus according to an embodiment of the present invention;

FIG. 3 is a sectional view illustrating an installation structure of a thermal conduction part of a liquid crystal display apparatus according to an embodiment of the present invention;

FIG. 4 is a sectional view illustrating another embodiment of an installation structure of a thermal conduction part of a liquid crystal display apparatus according to an embodiment of the present invention;

FIG. 5 is a sectional view illustrating an installation structure of an air fluidity generation unit of a liquid crystal display apparatus according to an embodiment of the present invention; and

FIG. 6 is a sectional view illustrating an inner air fluidity state by an air fluidity generation unit of a liquid crystal display apparatus according to an embodiment of the present invention.

Throughout the drawings, like reference numbers will be understood to refer to like elements, features and structures.

### DETAILED DESCRIPTION OF EXEMPLARY EMBODIMENTS

Reference will now be made in detail to various embodiments of the present invention, examples of which are illustrated in the accompanying drawings. The exemplary embodiments are not meant to be limiting, but rather are described below so as to provide a thorough and concise understanding of the present invention.

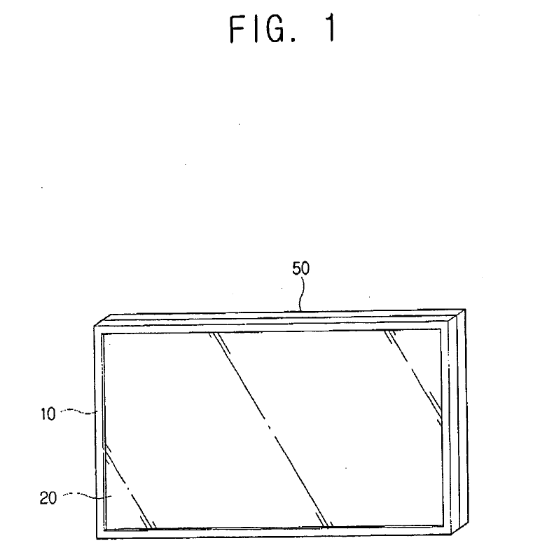

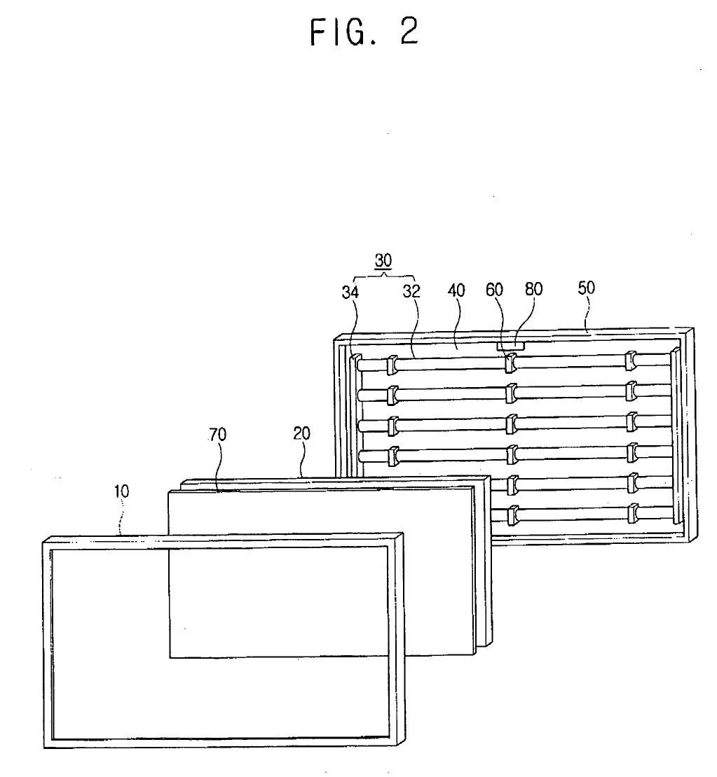

As illustrated in FIGS. 1 and 2, a liquid crystal display apparatus according to an embodiment of the present invention comprises a top chassis 10, a liquid crystal panel 20 provided behind the top chassis 10, a direct type back light unit (BLU) 30 which comprises a plurality of lamps 32 provided behind the liquid crystal panel 20, a reflection sheet 40 provided behind the direct type back light unit 30, a bottom chassis 50 provided behind the reflection sheet 40, a thermal conduction part 60 which is connected between the bottom chassis 50 and the plurality of lamps 32 and is adapted to conduct heat from the plurality of lamps 32 to the bottom chassis 50 while also firmly supporting the plurality of lamps 32. Embodiments of the present invention also preferably comprise an air fluidity generation unit 80 provided behind the liquid crystal panel 20, to force circulation of the inner air stratified by the heat from the plurality of lamps 32.

The top chassis 10 has a structure such that a central area is open so the liquid crystal panel 20 is exposed to the outside.

The liquid crystal panel 20 is supplied a predetermined voltage for a liquid crystal provided between a pair of substrates to control lights supplied by the direct type back light unit 30. Thus the liquid crystal panel 20 forms a picture.

The direct type back light unit 30 comprises a plurality of lamps 32 disposed at regular intervals behind the liquid crystal panel 20, and at least one electrode 34 provided at an end of the plurality of lamps 32.

The types, shapes and disposition of the lamps 32 may be variously changed so that the lamps preferably provide the whole liquid crystal panel 20 with light equally. Also the connection structure of the electrode 34 also may be changed according to the type of the lamps. The lamps typically used for a direct type back light unit are cool cathode fluorescence lamps (CCFLs) or external electrode fluorescence lamps (EEFLs).

The reflection sheet 40 is made of a material having high reflectivity, for reflecting the light emitted from the lamp 32 back to the liquid crystal panel 20. Thus the reflection sheet 40 is employed for minimizing the loss of light to the outside.

The bottom chassis 50 preferably has a structure capable of holding the reflection sheet 40 and the direct type back light unit 30, although other suitable arrangements may also be used. The bottom chassis 50 is preferably made of a material having high thermal conductivity so that heat pass through the thermal conduction part 60 to be radiated more easily.

The thermal conduction part 60 maintains the temperature of the lamp 32 at an appropriate level and decreases the relative temperature deviation among the plurality of lamps 32, thereby enhancing lamp life and lamp operation efficiency. The thermal conduction part 60 also preferably firmly supports the lamps 32.

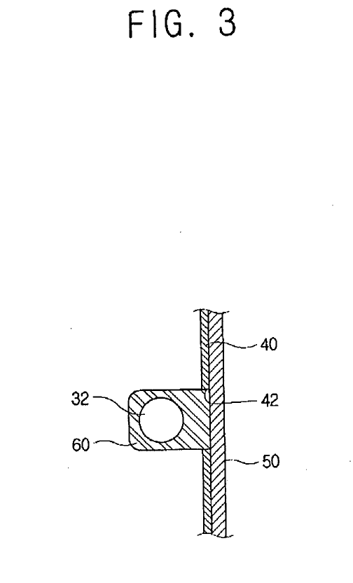

As illustrated in FIG. 3, a first side of the thermal conduction part 60 is connected with the internal surface of the bottom chassis 50. A second side of the thermal conduction part 60 passes through a through hole 42 formed in the reflection sheet 40, and contacts and supports the external surface of at least one of the lamps 32. Preferably several thermal conduction parts 60 contact and support the external surface of each lamp 32 in various places along the length of the lamp in order to enhance the heat radiation efficiency of the thermal conduction part 60 and to support the lamp more securely. In an exemplary embodiment of the present invention, thermal conduction parts 60 support the center and both sides of each lamp 32.

The supporting structure of the thermal conduction part 60 and the bottom chassis 50 may selectively be applied with bonding or caulking, as may be appropriate, considering various conditions such as assembly efficiency and thermal conduction.

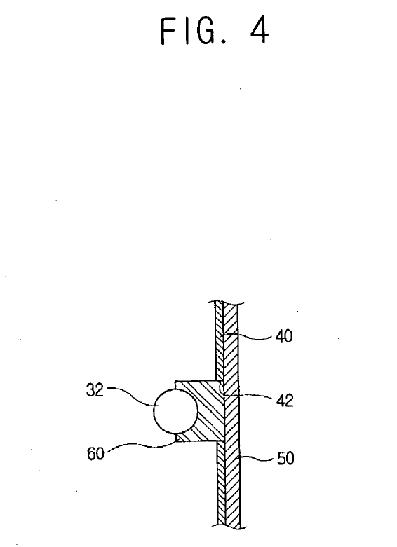

The thermal conduction part 60 preferably has a structure adapted to wrap the entire external surface as illustrated in FIG. 3 or may have a structure adapted to wrap a part of the lamp 32 as illustrated in FIG. 4. The lamp supporting structure of the thermal conduction part 60 may be variously changed as needed, while it is preferable but not necessary that the area contacted with the lamp 32 should be relatively large while minimally interfering with the light generated from the lamps 32 in order to efficiently radiate heat from the lamps 32.

The thermal conduction part 60 preferably passes through the through hole 42 formed in the reflection sheet 40 and directly contacts the external surface of the plurality of lamps 32, thereby preventing the lamp 32 from moving due to forces from the outside environment. Also the thermal conduction part 60 conducts heat from the lamps 32 to the bottom chassis 50, thereby decreasing the inner temperature.

Considering assembly efficiency, the thermal conduction parts 60 may be made as a module to supporting various portions of the plurality of lamps 32.

The thermal conduction part 60 is preferably made from a thermal conducting synthetic resin with high electrical insulation, although it may also be made from high thermal conducting materials such as metal that conduct electricity.

An optical sheet 70 is preferably provided to equalize brightness by increasing the efficiency of collecting light, which is supplied from the lamps 32 and incident upon the liquid crystal panel 20. The optical sheet 70 typically comprises a diffusion sheet for uniformly diffusing light supplied from the lamps 32, and a prism sheet for transforming a direction of travel of light diffused by the diffusion sheet at a predetermined angle.

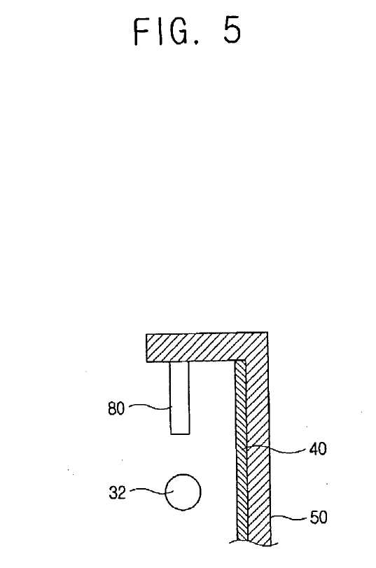

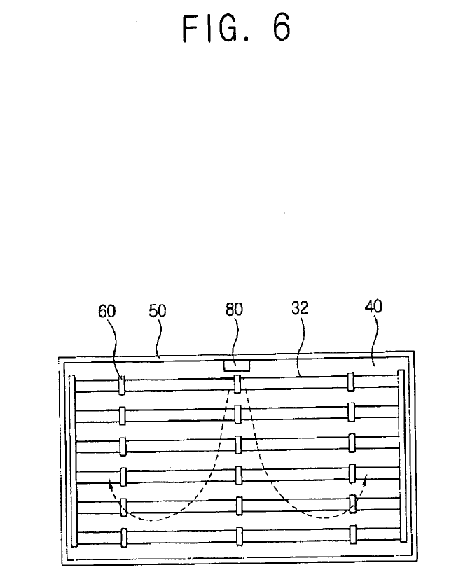

As illustrated in FIGS. 5 and 6, an air fluidity generation unit 80 that generates fluidity in the stratified inner air (stratified refers to a state in which the upper portion of the inner air has a higher temperature than the lower portion). Without an air fluidity generation unit 80, the inner air would become stratified by the heat from the plurality lamps 32. By circulating air, thermal conduction efficiency is increased, thereby equalizing the inner air temperature of the liquid crystal display apparatus.

For example, a portion of the heat generated from the plurality of lamps 32 conducts outside through the thermal conduction part 60, but the remainder of the heat remains inside in a stratified state. The air fluidity generation unit 80 circulates the stratified air. Thus the operation of the air fluidity generation unit 80 maximizes the cooling efficiency of the entire system even if the thermal transmission efficiency of the thermal conduction part 60 decreases.

The air fluidity generation unit 80 is preferably installed in the upper part of the bottom chassis 50 in order not to interfere with the reflecting sheet 40. Thus, the air fluidity generation unit 80 does not deteriorate the reflection efficiency of the reflection sheet 40. The installation numbers and locations of the air fluidity generation unit 80 may be changed according to design preference to generate fluidity in the stratified inner air while preventing the reflection efficiency of the reflection sheet 60 from deteriorating. The air fluidity generation unit 80 is preferably installed in at least one of an upper part, a lower part, and a side part of the bottom chassis 50.

The air fluidity generation unit 80 preferably has a blower made from a piezo-electric element, or a small fan, or any other device capable of generating blast power as needed.

Although the above described exemplary embodiment of the invention employed CCFL lamps and EEFL lamps, various types of lamps such as LED lamps may also be used. For example, in the case of an LED lamp, a thermal conduction part may be connected and installed between a printed-circuit board mounted with the LED lamp and a bottom chassis, therein supporting the printed-circuit board to conduct heat from the LED lamp to the bottom chassis in order to radiate the heat to the outside.

As described above, according to exemplary embodiments of the present invention, a thermal conduction part firmly supports the plurality of lamps and efficiently radiates heat from the plurality of lamps, therefore improving lamp life and lamp operating efficiency and preventing quality deterioration of the liquid crystal panel caused by the inner temperature rising.

What is claimed is:

1. A liquid crystal display (LCD) apparatus, comprising:
a liquid crystal panel;
a direct type back light unit provided behind the liquid crystal panel, which has a plurality of lamps;
a reflection sheet provided behind the direct type back light unit;
a bottom chassis provided behind the reflection sheet; and
a thermal conduction part connected between the bottom chassis and at least one of the plurality of lamps, which conducts heat from the lamp to the bottom chassis.

2. The LCD apparatus of claim 1, wherein the thermal conduction part comprises:
a first side supported by the bottom chassis; and
a second side passing through the reflection sheet, and contacting and supporting the external surface of the lamp.

3. The LCD apparatus of claim 2, wherein a plurality of thermal conduction parts contacts and supports various portions of the plurality of lamps.

4. The LCD apparatus of claim 1, wherein the thermal conduction part is made of a material having high thermal conduction and electrical insulation.

5. The LCD apparatus of claim 4, wherein the thermal conduction part is made from a synthetic resin with high thermal conductivity.

6. The LCD apparatus of claim 1, wherein the LCD apparatus further comprises an air fluidity generation unit to circulate inner air.

7. The LCD apparatus of claim 6, wherein the air fluidity generation unit is installed such that it does not interfere with light reflected by the reflection sheet and transmitted towards the liquid crystal panel.

8. The LCD apparatus of claim 7, wherein the air fluidity generation unit is located in at least one of an upper part, a lower part, and a side part of the bottom chassis.

9. The LCD apparatus of claim 6, wherein the air fluidity generation unit comprises a blower.

10. The LCD apparatus of claim 9 wherein the blower comprises a piezo-electric element.

11. The LCD apparatus of claim 9 wherein the blower comprises a fan.
